(19) United States
(12) Patent Application Publication
(10) Pub. No.: US 2002/0119078 A1
(43) Pub. Date: Aug. 29, 2002

(54) Device and method for addressing a microfluidic cartridge

(76) Inventors: Petr Jansa, Kirkland, WA (US); Jeffrey M. Houkal, Bellevue, WA (US)

Correspondence Address: JERROLD J. LITZINGER, SENTRON MEDICAL, INC., 4445 LAKE FOREST DR., SUITE 600, CINCINNATI, OH, 45242, US

(21) Appl. No.: 09/864,985

(22) Filed: May 24, 2001

Related U.S. Application Data
(60) Provisional application No. 60/206,878, filed on May 24, 2000.

(51) Int. Cl. B01L 11/00

(52) U.S. Cl. 422/103

(57) ABSTRACT

A device and method of addressing a microfluidic cartridge to interface with external fluid supplies and external activation of internal control devices. The fluid interface couples the microfluidics of the cartridge to the macrofluidics of the external system with little or no dead volume.

### CROSS REFERENCE TO RELATED APPLICATIONS

This application claims benefit from U.S. Provisional patent application Ser. No. 60/206,878, filed May 24, 2000, which application is incorporated herein by reference.

### BACKGROUND OF THE INVENTION

1. Field of the Invention

This invention relates generally to microfluidic devices for performing analytic testing, and, in particular, to a device and method for interfacing a microfluidic cartridge with external fluid supplies and valve controls.

2. Description of the Related Art

Microfluidic devices have recently become popular for performing analytical testing. Using tools developed by the semiconductor industry to miniaturize electronics, it has become possible to fabricate intricate fluid systems which can be inexpensively mass produced. Systems have been developed to perform a variety of analytical techniques for the acquisition of information for the medical field.

Valves and valve activating devices are well known in the art. U.S. Pat. No. 4,499,756, which issued on Feb. 19, 1985, is directed to a test controller for closure of ganged, cam operated main control valves in a steam turbine. The controller incrementally controls one set of main control valves in the closing direction while controlling the other set of main control valves in the opposite direction. U.S. Pat. No. 4, 696,195, which issued on Sep. 29,1987, is directed to a valve having a plurality of orifices with a resilient closure membrane adjacent thereto which is positioned to yield in response to a pressure differential so as to permit flow between respective ports. U.S. Pat. No. 4,858,885, which issued Aug. 22, 1989, is directed to a valve having a flexible valve sheet member which is flexed to open and close fluid passageways. U.S. Pat. No. 5,743,960, which issued Apr. 28, 1998, is directed to a reagent dispensing apparatus which includes a positive displacement syringe pump in series with a solenoid valve dispenser which is opened and closed at a predetermined frequency and duty cycle to dispense droplets of reagent onto a target substrate at a metered flow rate. U.S. Pat. No. 5,755,942, which issued May 26, 1998, is directed to a system for processing a plurality of syntheses by using an array of microelectronic and fluidic transfer devices for carrying out various processes.

A sample microfluidic analysis instrument for performing analytical testing which uses a disposable fluidic analysis cartridge is disclosed in U.S. patent application Ser. No. 09/080,691, which was filed on May 18, 1998, the disclosure of which is incorporated herein by reference in its entirety. This instrument includes a cartridge holder, a low cytometric measuring apparatus positioned for optical coupling with a flow cytometric measuring region on the cartridge, and a second measuring apparatus positioned to be coupled with a second analysis region on the cartridge. The cartridge holder includes alignment markings to mate with cartridge alignment markings. It also includes pump mechanisms to couple with pump interfaces on the cartridges and valve mechanisms to couple with valve interfaces on the cartridge.

In this type of system, valve and pump mechanisms are external to the cartridge, while the cartridge includes the valve and pump interfaces. Upon loading the cartridge into the apparatus, the valve and pump mechanisms engage the valve and pump interfaces. Thus, it is critical that the interfaces provide an efficient and precise coupling between the cartridge of the external mechanisms. In addition, it is imperative that these external devices provide for a smooth flow of the fluids into and out of the cartridge to ensure accurate measurements within a microfluidic analysis system.

Therefore, it is desirable to provide a device and method for efficiently interfacing a microfluidic cartridge with external macrofluidic supplies, as well as for addressing the microfluidic circuitry internal to the cartridge.

### SUMMARY OF THE INVENTION

It is therefore an object of the present invention to provide a device which allows a microfluidic cartridge to be coupled to a plurality of external devices which supply the fluids which are essential for the cartridge in performing analyses.

It is also an object of the present invention to provide a device which accurately connects a microfluidic cartridge to a plurality of external devices which serve to provide external forces for operating different features of the cartridge.

It is a further object of the present invention to provide a method by which a microfluidic device may be accurately coupled to external sources to enable the cartridge to perform a desired analysis.

These and other objects of the present invention will be more readily apparent from the description and drawings which follow.

### BRIEF DESCRIPTION OF THE DRAWINGS

FIG. 1 is a fragmentary plan view of a microfluidic analysis cartridge for use with the present invention;

FIG. 2 is a perspective view of a system which includes the present invention;

FIG. 3 is another view of the system shown in FIG. 2; and

FIG. 4 is another view of the system shown in FIG. 2.

### DETAILED DESCRIPTION OF THE PREFERRED EMBODIMENT

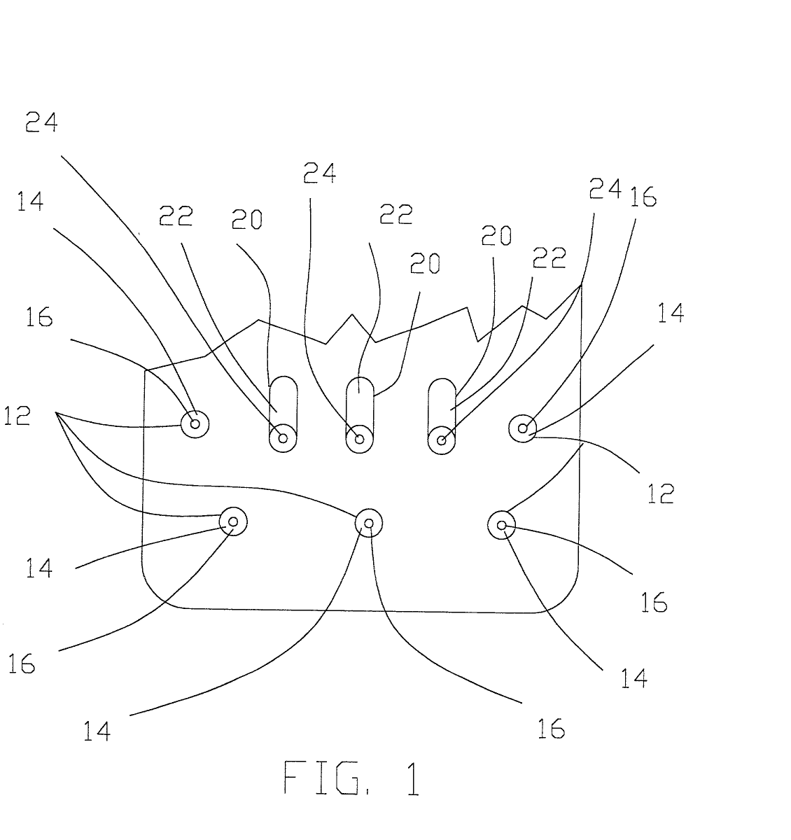

Referring now to FIG. 1, there is shown a section of a liquid analysis cartridge or card, generally designated at 10. Cartridge 10 is described in detail in U.S. patent application No. 09/080,091, which was filed May 18, 1998, and is herein incorporated by reference in its entirety. A series of circular apertures 12 are formed within cartridge 10 to allow fluid to flow from outside cartridge 10 to the interior of the card to be used in the analysis process. A series of fluid seals 14 are located within cartridge 10 contacting the inside surface of apertures 12. Seals 14 also contact a series of ports 16 within cartridge 10 which lead to the interior of cartridge 10. Ports 16 allow desired fluids which are necessary for conducting various tests to be pumped into and out of cartridge 10 from analysis channels.

Cartridge 10 also contains a series of slots 20 in which a series of actuators 22 are located. At one end of each of actuators 22 is a port 24. In operation, actuators 22 are selectively operated through slots 20 from the exterior of cartridge 10 to open and close ports 16 as desired to perform various analyses within channels of cartridge 10.

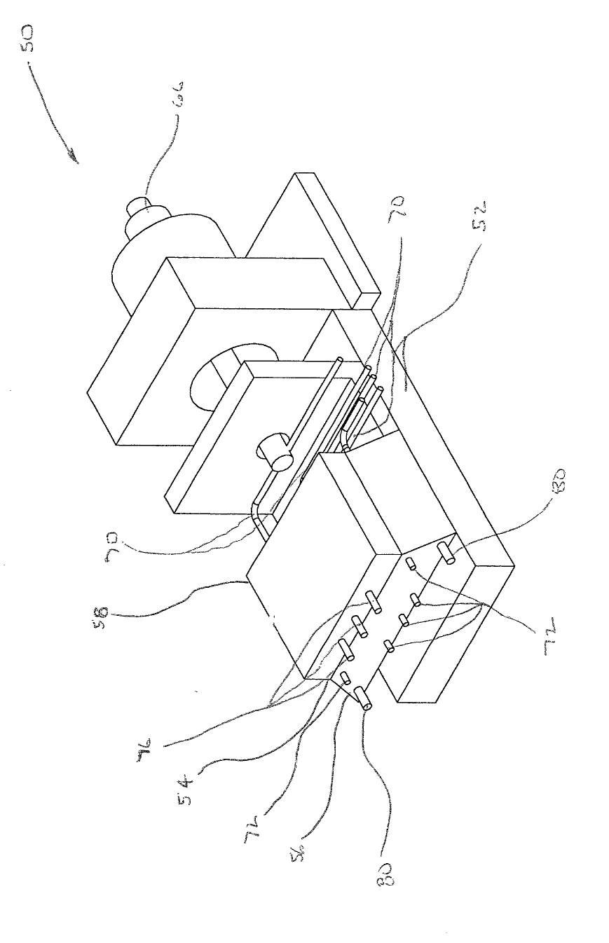

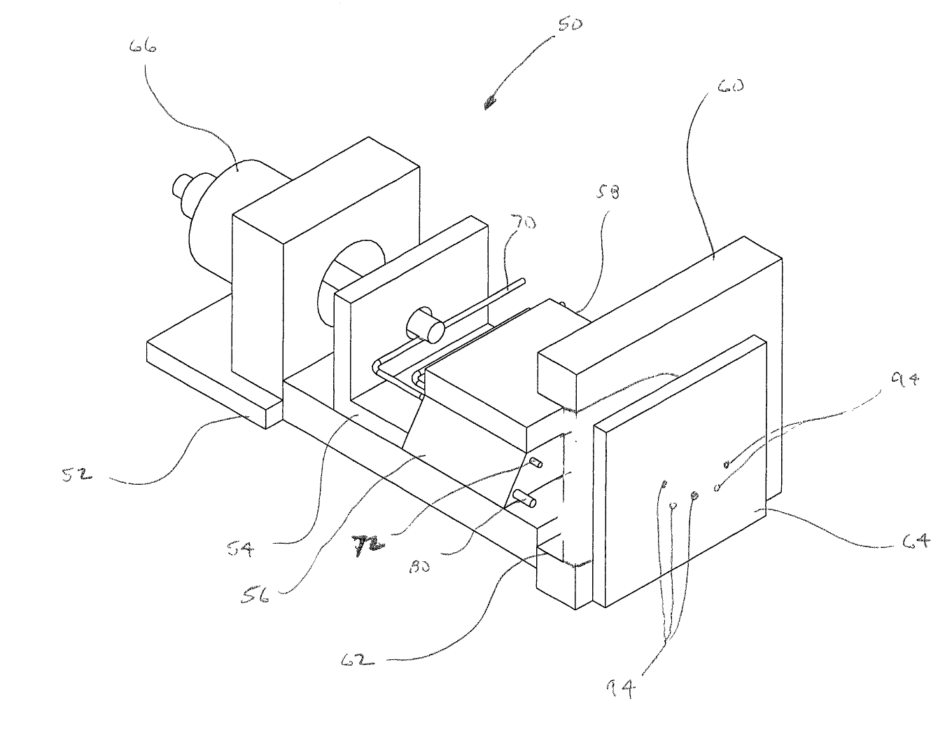

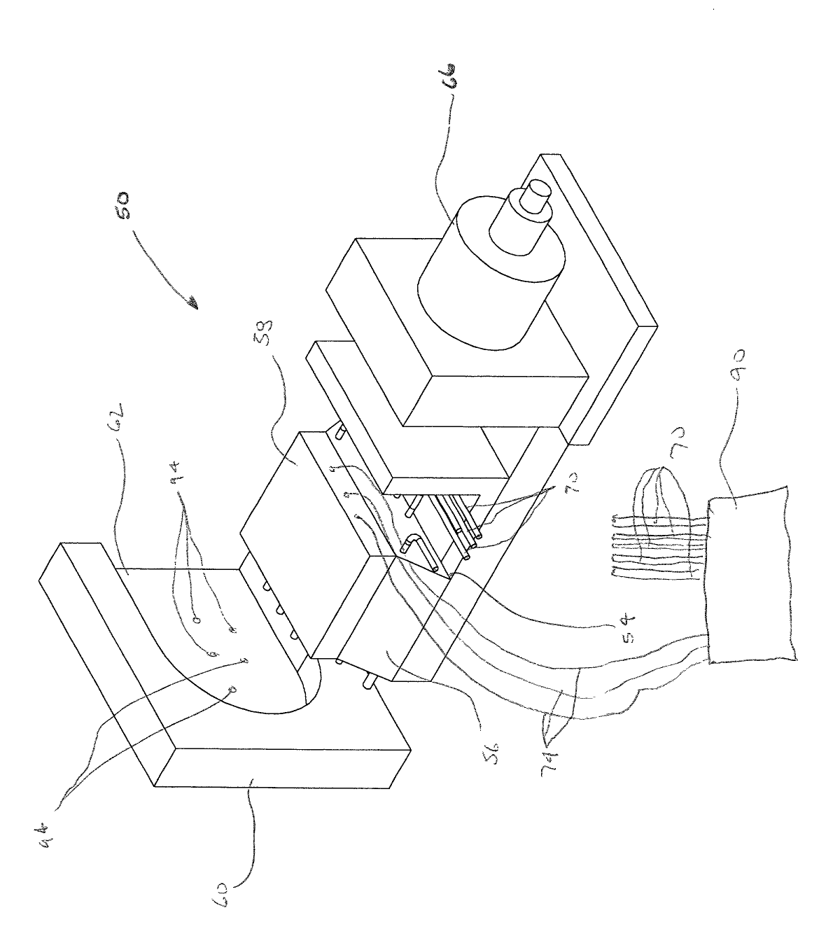

FIGS.2-5 show an apparatus for carrying out a preferred embodiment of the present invention. Referring now to FIG. 2, an interfacing device, generally indicated at 50, contains a frame 52 having a cartridge engaging manifold 54 slidably mounted thereupon. Manifold 54 consists of a fluid interface section 56 and a valve actuator section 58. A cartridge holding unit 60 is fixedly mounted on frame 52 in perpendicular relationship to manifold 54. Unit 60 contains a groove 62 such that a cartridge such as cartridge 10 can be inserted into unit 60 and locked into place such that it solidly captured within unit 60. A tip cleaning station 64 is affixed to frame 52 on the side of unit 60 opposite manifold 54 in parallel relationship to groove 62 within unit 60.

A linear drive motor 66 is rotatably coupled to manifold 54, which is slidably mounted on frame 52. In operation, motor 66 rotates in response to a command to move manifold 54 into and out of an operating position adjacent cartridge 10 mounted within groove 62 of unit 60.

A series of tubes 70 are connected to section 56, while a series of corresponding tubing tips 72 extend from the opposite end of section 56. Tubes 70, which are preferably constructed from a sturdy material such as Teflon, carry the fluids necessary for cartridge 10 to perform the desired analysis. A series of cables 74 are connected to section 58, while a series of a valve actuator arms 76 extend from the opposite end of section 78 upon receipt of a command via cables 74. Actuator arms 76 act to selectively operate valves within cartridge 10.

Also located on interface section 56 is a pair of locating pins 80. Pins 80 are used to insure correct orientation between manifold 54 and cartridge 10. Pins 80 may have locating holes in either the cartridge or in cartridge holding unit 60. When pins 80 are securely located within the proper receptacles, tips 72 are assured of proper alignment with apertures 12, such that fluids will be accurately delivered to cartridge 10 for analysis purposes. In addition, pins 80 also act to align actuator arms 76 with actuators 22 in cartridge 10.

Tubes 70 extend from the end of fluid interface section 56 to a control unit 90 (FIG. 2). Unit 90 serves to operate interfacing device 50. Unit 90 provides the proper fluids to cartridge at the proper times and intervals. Control unit 90 also provides the necessary signals to operate valve actuator arms 76 at the proper times. Control unit 90 is also responsible for operating motor 66 to adjust manifold 54 into position.

Tip cleaning station 64 is provided with a series of apertures 94. Apertures 95 which align with tips 72 on section 56, are filled with an absorbing material, such as filter paper, cellulose, or any other material which can wipe a droplet from the tip. It may also be constructed from silicon rubber or plexiglass.

In operation, interfacing device 50 is loaded with cartridge 10 by sliding the cartridge into groove 62 where it is tightly held in position and it cannot shift. A locking mechanism may be added to insure that cartridge 10 does not move during operation. After cartridge 10 has been positioned on cartridge holding unit 60, manifold 54 may be advanced until locating pins 80 enter the locating holes on either cartridge 10 or unit 60. At this time, unit 50 is properly aligned for use.

Tube tips 72 may be individually advanced by control unit 90 to enter into apertures 12 and are sealed tightly with fluid seals 14 with little or no dead volume. In addition, valve actuator 76arms may be advanced using control unit 90 to contact valve actuators 22 as is necessary.

After the desired analysis has been performed by cartridge 10, manifold 54 is retracted away from unit 60 so that cartridge 10 may be removed. Tips 72 can be cleaned at this time.

Manifold 54 is advanced toward unit 60 until it is adjacent unit 60 and tip cleaning station 64. Tips 72 may then be advanced under command from control unit 90 such that tips 72 extend into apertures 94, where tips 76 contact the absorbing material such that any excess droplets or material can be removed. This procedure may also be performed before cartridge 10 is mounted within groove 62 in unit 60.

While the present invention has been shown and described in terms of several embodiments thereof, it will be understood that this invention is not limited to these particular embodiments and that many changes and modifications may be made without departing from the true spirit and scope of the invention as defined in the appended claims.

What is claimed is:

1.) A device for interfacing a microfluidic analysis cartridge having at least one internal fluid port and at least one internal valve with a set of external fluid reservoirs, comprising:
a frame;
means for holding a microfluidic cartridge mounted on said frame;
at least one fluid reservoir having a transferring tube;
and means for automatically coupling said tube from said reservoir to said internal fluid port on said cartridge;
such that coupling occurs with little or no dead volume.

2.) The device of claim 1, further comprising means for selectively actuating said at least one internal valve within said cartridge.

3.) The device of claim 2, wherein said coupling means and said valve actuating means are mounted on a manifold slidably mounted on said frame for movement with respect to said cartridge holding means.

4.) The device of claim 3, further comprising a motor for slidably moving said manifold with respect to said cartridge holding means.

5.) The device of claim 1, further comprising means mounted on said frame for cleaning the ends of said tubes prior to coupling to said internal fluid port on said cartridge.

6.) The device of claim 5, wherein said cleaning means comprises an absorbing material.

7.) The device of claim 6, wherein said absorbing material consists of cellulose.

8.) A method of interfacing a microfluidic analysis cartridge having internal fluid ports and internal valves with a set of fluid reservoirs, comprising the steps of:
mounting a microfluidic analysis cartridge having internal fluid ports and internal valves rigidly to holder mounted to a frame having a manifold slidably mounted with respect to said holder, said manifold having at least one tube tip extending therefrom and coupled at its other end to a fluid reservoir;
slidably shifting said manifold toward said cartridge mounted in said frame until said at least one of said tube tips couples a fluid port on said cartridge, with said coupling occurring with little or no dead volume.

9.) The method of claim 8, further comprising slidably shifting said manifold to a tip cleaning station such that said tips are wiped by an absorbing material.

10.) The method of claim 9, wherein said tip cleaning step occurs after said cartridge is removed from said holder on said frame.

11.) The method of claim 9, wherein said tip cleaning step occurs before said cartridge is mounted to said holder on said frame.
